(19) United States
(12) Patent Application Publication
(10) Pub. No.: US 2025/0202787 A1
(43) Pub. Date: Jun. 19, 2025

(54) CALCULATING APPLICATION SERVICE ENERGY CONSUMPTION IN A WIRELESS COMMUNICATION NETWORK

(71) Applicant: LENOVO (SINGAPORE) PTE. LTD, Singapore (SG)

(72) Inventors: EMMANOUIL PATEROMICHELAKIS, Viersen (DE); Ishan VAISHNAVI, Munich (DE); Dimitrios KARAMPATSIS, Middlesex (GB)

(21) Appl. No.: 18/849,158

(22) PCT Filed: May 13, 2022
(86) PCT No.: PCT/EP2022/063078

§ 371 Date: Sep. 20, 2024

(30) Foreign Application Priority Data
Mar. 23, 2022 (GR) 20220100256

(51) Int. Cl. H04L 43/08; H04L 41/5009

(52) U.S. Cl. CPC H04L 43/08; H04L 41/5009

(57) ABSTRACT

There is provided a method for providing energy data for an application service. The method comprises receiving an energy data requirement for the application service from a requesting node, and determining a set of energy data producers associated with the application service from which to collect energy data based on the energy data requirement. The method further comprises collecting a first set of energy data from the set of energy data producers, and computing a second set of energy data for the application service based on the first set of energy data. The method 400 further comprises sending a report comprising the second set of energy data to the requesting node.

### FIELD

The subject matter disclosed herein relates generally to the field of calculating application service energy consumption in a wireless communication network. This document defines methods and apparatus, the apparatus including at least one network node.

### BACKGROUND

There is a trend to reduce the impact of ICT equipment on the environment and a desire to reduce the network operator's operational expenses, 3GPP has developed standards for the energy efficiency of mobile networks. These standards typically follow a two-step approach: first defining Energy Efficiency (EE) KPIs & methods to measure them and then defining use cases and solutions for Energy Saving (ES).

The energy efficiency of a mobile network can be defined by its performance divided by its energy consumption, where the definition of performance depends on the network entity it applies to. For a unit of energy consumed by the mobile network, the higher its performance is, the higher its energy efficiency is. Work is now ongoing to define the performance of a 5G core network and of network slices. In the Network Slice as a Service (NSaaS) model, a customer may express requirements to a provider about the energy efficiency of the network slice they want to order. The performance of a network slice is defined in terms of data volume for enhanced Mobile Broadband (eMBB), the reduction of latency for Ultra Reliable Low Latency Communications (URLLC), number of registered subscribers or active user equipment for massive IoT.

### SUMMARY

There is a need for a mobile network operator (MNO) to make a determination of the expected energy consumption for its network and the impact on the devices connected thereto when deploying a communication service and/or slice to meet the requirements of a new application service.

Disclosed herein are procedures for calculating application service energy consumption in a wireless communication network. Said procedures may be implemented by at least one network node.

There is provided a method for providing energy data for an application service. The method comprises receiving an energy data requirement for the application service from a requesting node, and determining a set of energy data producers associated with the application service from which to collect energy data based on the energy data requirement. The method further comprises collecting a first set of energy data from the set of energy data producers, and computing a second set of energy data for the application service based on the first set of energy data. The method further comprises sending a report comprising the second set of energy data to the requesting node.

There is further provided a network node arranged to providing energy data for an application service, the network node comprises a receiver, a processor, and a transmitter. The receiver is arranged to receive an energy data requirement for the application service from a requesting node. The processor is arranged to determine a set of energy data producers associated with the application service from which to collect energy data based on the energy data requirement. The processor is further arranged to collect a first set of energy data from the set of energy data producers, and to compute a second set of energy data for the application service based on the first set of energy data. The transmitter is arranged to send a report comprising the second set of energy data to the requesting node.

There is further provided a method for obtaining energy data for an application service, the method comprising: sending an energy data requirement for the application service to a data collection node; and receiving from the data collection node a report comprising a second set of energy data, the second set of energy data computed from a first set of energy data, the first set of energy data collected from a set of energy data producers determined to be associated with the application service from which to collect energy data based on the energy data requirement.

There is further provided a network node for obtaining energy data for an application service, the network node comprising a transmitter and a receiver. The transmitter is arranged to send an energy data requirement for the application service to a data collection node. The receiver arranged to receive from the data collection node a report comprising a second set of energy data, the second set of energy data computed from a first set of energy data, the first set of energy data collected from a set of energy data producers determined to be associated with the application service from which to collect energy data based on the energy data requirement.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for calculating application service energy consumption in a wireless communication network will now be described, by way of example only, with reference to the accompanying drawings, in which:

FIG. 1 illustrates an example representation of a system for implementing the arrangements described herein;

FIG. 2 depicts a user equipment apparatus;

FIG. 3 depicts further details of a network node;

FIG. 4 illustrates a method for providing energy data for an application service;

FIG. 5 illustrates a method for obtaining energy data for an application service;

FIG. 6 illustrates a message exchange between 5GC and OAM in an analytics phase;

FIG. 7 illustrates an on-network Application Data Analytics Enablement (ADAE) model;

FIG. 8 illustrates an off-network ADAE model;

FIG. 9 illustrates a system for implementing an application service for gaming;

FIG. 10 is a messaging diagram illustrating a system as described herein; and

FIG. 11 is a messaging diagram illustrating an alternative system as described herein.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

Next generation mobile communication systems, such as 5G-advanced and 6G are expected to accommodate more demanding services, such as extended reality (XR), artificial intelligence (AI), machine learning (ML). These more demanding services will require greater energy consumption at the device side as well as the network side. The impact of these demanding services on devices and the network to support such services will be huge and difficult to predict.

An Energy Efficiency (EE) metric requires first the setting of an optimization target (e.g. network element, slice, end to end application service) and then the capture of energy consumption contributor factors (these depend on involved UEs, apps, and network nodes). Different factors contribute to the energy consumption for an application service. An application service in this invention is defined as a service between two or more applications which use a wireless communication network for communication. By way of example, the wireless communication network may comprise a 5G/6G system. The two or more applications may be executed by any combinations of clients and servers.

A factor contributing to Energy Efficiency is the processing and propagation needed for user plane data transfers considering factors such as the transmission type and mode. Such factors include whether the data transfer is uplink (UL), downlink (DL), sidelink (SL), unicast, multicast, broadcast, edge and/or cloud data network (DN) deployments.

Another factor contributing to Energy Efficiency is the processing and propagation needed for Control plane services which are consumed by the application (exposable, network internal)

Another factor contributing to Energy Efficiency is the processing and propagation needed for management plane services which are consumed by the application. Such management plane services may be exposable, or internal to an Operations, Administration and Maintenance (OAM).

Another factor contributing to Energy Efficiency is the processing and propagation needed for Enablement layer servcies, as defined in 3GPP SA6. Enablement layer services are consumed by the application service as value-added capabilities at the edge or in the cloud.

When deploying a communication service to meet the requirements of the application service the mobile network operator (MNO) needs to be aware of the expected energy consumption for its network and the impact on the devices connected thereto. For example, the application service requirements may be requirements for a gaming app which may require a minimum latency. At the same time, a customer (such as an application service provider (ASP) or vertical) should verify that the application service doesn't consume significant energy in either the end user devices or in the data network side. Some form of optimization is needed and this optimization requires interaction between the customer (such as ASP or vertical) and the MNO for ensuring that the communication requirements of the application service are energy sustainable.

Such energy sustainability may be assessed by the OAM, but only from a communication service point of view taking as inputs measurements from network elements. However, such a perspective misses the energy sustainability from an application layer perspective. The application layer perspective of energy sustainability is required to assess the energy consumed based on factors such as interactions between application entities, API usage, use of multiple underlying networks, use of edge/cloud resources, for example.

There is provided herein a mechanism to take into account application layer data to make more sophisticated and holistic energy data analysis for a communication service and its mapping to an application service. The application layer data may comprise customer data. Such data tends to allow for analyzing the impact of different application traffic to network/slice energy efficiency, or for charging the customer in a vertical-tailored manner, or for enabling the vertical customer to adapt the application behavior and placement to optimization energy efficiency.

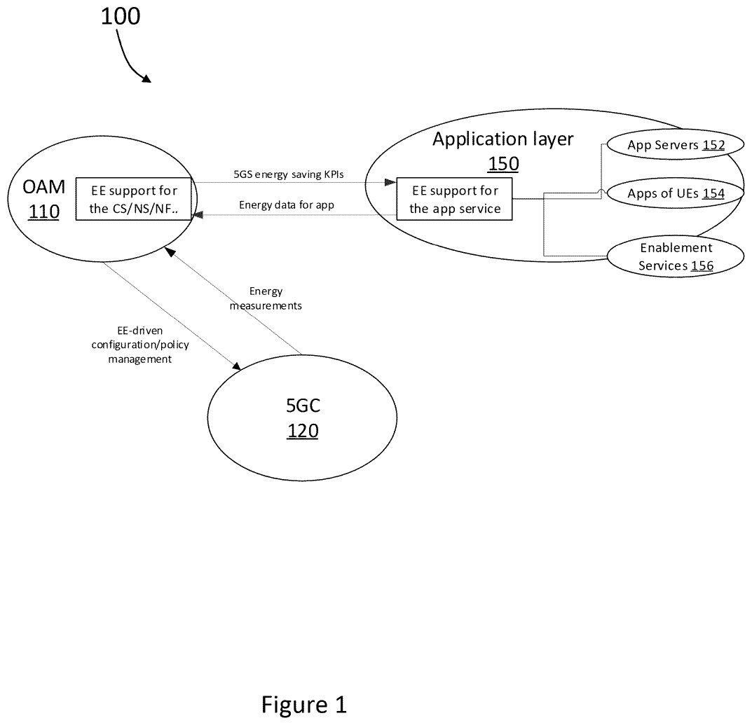

FIG. 1 illustrates an example representation of a system for implementing the arrangements described herein. The system 100 comprises an OAM 110, a 5G core (5GC) 120, and an application layer 150. The application layer 150 comprises a plurality of application servers 152, a plurality of applications 154 executed by one or more UEs, and a plurality of enablement services 156. Enablement services 156 may be provided by application or edge enablement layer entities. Such services and entities are specified in 3GPP SA6 e.g. in SEAL (3GPP TS 23.434 v17.4.0), in EDGEAPP (3GPP TS 23.558 v17.2.0), in V2XAPP (3GPP TS 23.286 v17.3.0), in ADAES (3GPP TR 23.700-36 v0.1.0).

The OAM 110 includes energy efficiency (EE) support for a Communication Service (CS), Network Slice (NS), Network Function (NF), Application Function (AF), and edge function. The OAM 110 sends EE driven configuration and policy management requirements to the 5G Core 120. The OAM 110 receives energy measurements from the 5G Core 120, and receives energy data for an application from the application layer 150. The OAM 110 sends 5G system energy saving Key Performance Indicators (KPIs) to the application layer 150. The application layer 150 includes energy efficiency (EE) support for the application service.

There is presented herein a mechanism to facilitate the calculation of how much energy is consumed by a communication service that can be associated to a particular vertical customer who owns the service.

There is presented herein a mechanism to allow a MNO to monitor the application service energy consumption and energy efficiency, and whether an Energy KPI for the service profile is met or whether further optimization is needed.

There is presented herein a mechanism to determine what interaction is needed with a third party ASP and/or vertical to decide and negotiate an Energy KPI and/or an Energy Service Level Agreement (SLA), based on a change of the consumption for different areas and times.

### #Generic UE

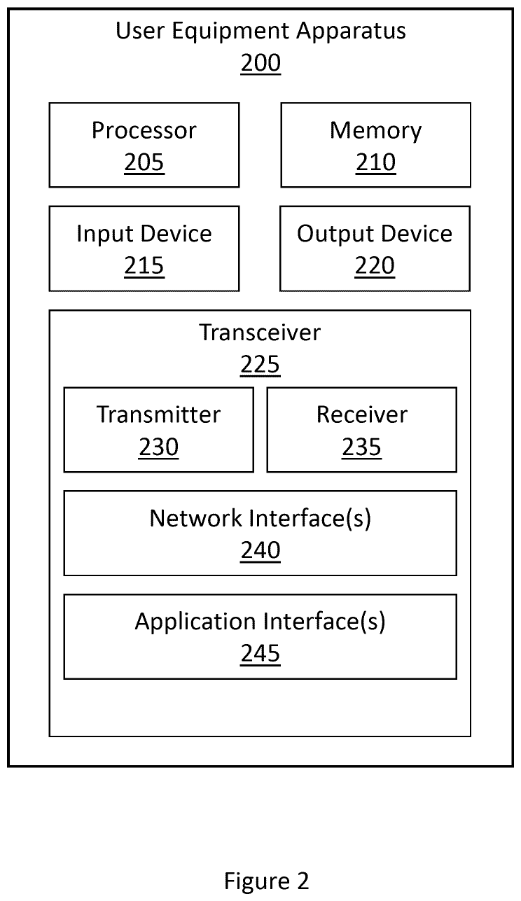

FIG. 2 depicts a user equipment apparatus 200 that may be used for implementing the methods described herein. The user equipment apparatus 200 is used to implement one or more of the solutions described above. The user equipment apparatus 200 may comprise a VAL UE 710, a UE 810, 820, or a VAL UE 1141, 1142, 1143 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

### #Generic Network Node

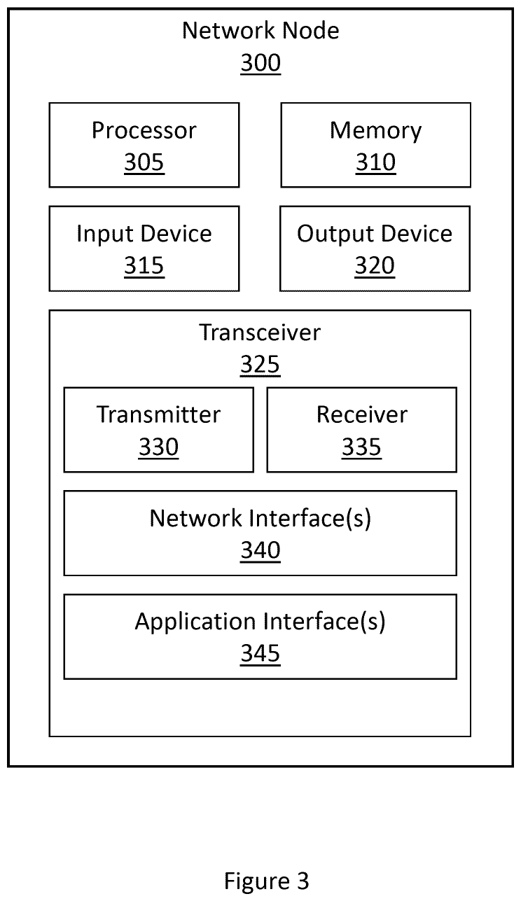

FIG. 3 depicts further details of the network node 300 that may be used for implementing the methods described herein. The network node 300 may be one implementation of an entity in the wireless communications network. The network node 300, may comprise an Application Energy Data Producer (AEDP) 1032, 1132, or an Application Energy Data Consumer (AEDC) 1030, 1130 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 May support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

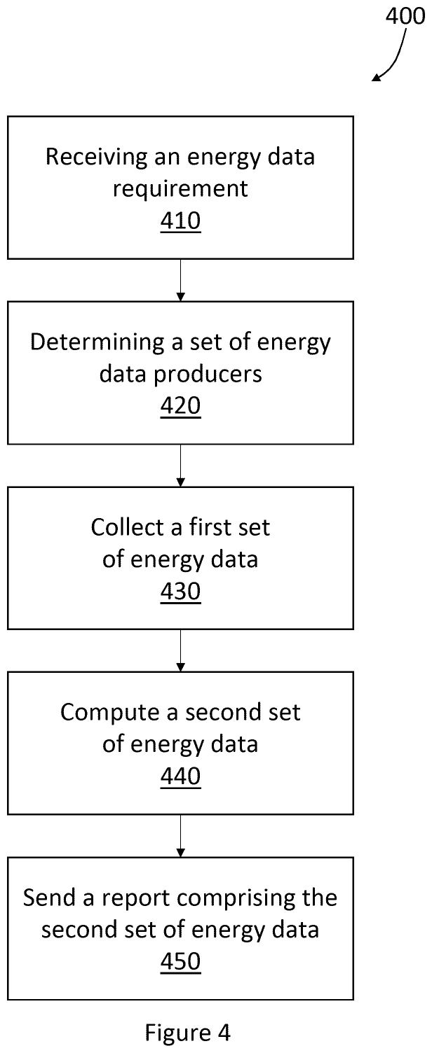

FIG. 4 illustrates a method 400 for providing energy data for an application service. The method 400 comprises receiving 410 an energy data requirement for the application service from a requesting node, and determining 420 a set of energy data producers associated with the application service from which to collect energy data 20) based on the energy data requirement. The method 400 further comprises collecting 430 a first set of energy data from the set of energy data producers, and computing 440 a second set of energy data for the application service based on the first set of energy data. The method 400 further comprises sending 450 a report comprising the second set of energy data to the requesting node.

The method described herein tends to allow a party, such as a mobile network operator to obtain a calculation of the amount of energy consumed by an application service. The application service may be provided using a wireless communication network. The method described herein also tends to provide a mechanism to calculate the energy consumed by a communication service that can be associated to a particular vertical customer who owns the service. Further, it may facilitate monitoring by the mobile network operator (MNO), the application service Energy consumption and efficiency and whether the Energy key performance indicator (KPI) for the service profile is met or further optimization is needed. Further still, it may define what interaction is needed with the 3rd party application service provider (ASP) or/vertical to decide and negotiate the Energy KPI and/or service layer agreement (SLA), based on change of the consumption for different areas and time.

The determination of a set of energy data producers within the application service from which to collect energy data comprises identifying a service area for which the energy data requirement applies, and selecting energy data producers within the service area.

The method may be performed by an Application Energy Data Producer (AEDP). The AEDP may be an application enablement entity such as an Application Data Analytics Enablement Service (ADAES) or Service Enabler Architecture Layer (SEAL) or an Edge Enabler Server (EES) or a SEAL-Data Delivery (SEAL-DD) server. The request for energy related data for an application service may be received from an Application Energy Data Consumer (AEDC). The AEDC may be an application, an application server, an application enabler server, an application client, or a network entity. The network entity may be the mobile network operator.

The energy data requirement may comprise at least one of an energy KPI, a request for energy related data, and a time and area of interest. The energy data requirement may comprise at least one of a Key Performance Indicator (KPI) for the application service, an energy KPI, a quality level for the application service, a request for energy related data, and a time and area of interest. The energy data requirement may be a general KPI. For example, the general KPI may define a certain latency or throughput.

The set of energy data producers within the application service for a managed entity comprise at least one of: energy data producers for one or more application sessions; energy data producers from one or more data networks; and an energy data producer arranged to collect energy data from a managed entity.

The managed entity may comprise at least one of a Communication Service (CS), Network Slice (NS), Network Function (NF), Application Function (AF), or edge function. The energy data may comprise energy parameters from a managed entity.

The set of energy data producers within the application service may include a function within an edge platform. The set of energy data producers within the application service may obtain energy data for a network slice associated with the application service to be measured.

The first set of energy data may comprise at least one of: real time battery consumption data for the application service, edge platform energy consumption data, network energy consumption and/or efficiency data, network slice or slice subnet energy consumption and/or efficiency data, radio access network energy consumption and/or efficiency data, energy consumption and/or efficiency data for a managed entity, and application server consumption data. At least one edge platform may host an application server.

The second set of energy data may be at least one of Application Energy Efficiency (AEE), Application Energy Consumption (AEC), and Application Data Volume (ADV). The second set of energy data may comprise an AEC parameter, an AEE parameter, an ADV parameter or a combination thereof.

The energy data requirement for the application service from a requesting node may define a target area within which energy data is to be collected. Where a target area is not defined, the request may apply to a network slice or the entire network. The target area may be a geographical area, service area or topological area. A topological area may be defined according to the network topology. For example, a topological area may be defined as a list of cells. The topological area may be defined as the area where the determination and computation elements (1b/1d) apply.

The request for energy related data may indicates at least one of: the data needed, the application service profile, the application service identity (ID), service requirements, traffic requirements, the public land mobile network (PLMN) ID to be used, the non-public network (NPN) ID to be used, the area of subscription, and the time and criteria for the reporting.

The data needed may comprise any combination of AEE, AEC, ADV. The area of subscription may be a target area. The target area may be defined by geographical area, topological area, or by way of an Edge Data Network list.

The producer selected may depend on the type of requested data. For example, for ADV, from the DN side, data may be collected by the application servers or the networking stacks at the edge/cloud, or based on API usage by application enablement services/CAPIF. For AEC, data from the edge/cloud platform may be collected for the vCPU usage. For AEE, data may be derived based on AEC and ADV, or by requesting/receiving such data from application specific layer (e.g. in similar manner as receiving quality of experience (QoE) measurements).

The KPI data may comprise per slice instance energy consumption, or per slice subnet energy, or per RAN energy levels (for the list of cells within the service area) or the energy levels for a given geographical area. Where energy KPI data is requested from an Operations, Administration and Maintenance (OAM), such a request may require authorization. For example, where the method is performed by a network entity receiving KPI data from the OAM may require that the network entity is a trusted entity of the OAM and is authorized for receiving this data. The method may further comprise authorizing the request.

The set of energy data producers may include a plurality of vertical application layer (VAL) User Equipments (UEs). The energy data producers may include VAL UEs, and the energy data may comprise battery drain information. Then, the determination of a set of energy data producers within the application service from which to collect energy data comprises selecting the VAL UEs within a service area for which the energy data requirement applies.

The first set of energy data may comprise one or more of: battery status when a service starts, battery status when a service terminates, time of service, activity of applications other than the application service, contribution of the application service to the battery drain if the UE Operating System support.

There is further provided a network node arranged to providing energy data for an application service, the network node comprises a receiver, a processor, and a transmitter. The receiver is arranged to receive an energy data requirement for the application service from a requesting node. The processor is arranged to determine a set of energy data producers associated with the application service from which to collect energy data based on the energy data requirement. The processor is further arranged to collect a first set of energy data from the set of energy data producers, and to compute a second set of energy data for the application service based on the first set of energy data. The transmitter is arranged to send a report comprising the second set of energy data to the requesting node. The network node may be an AEDP.

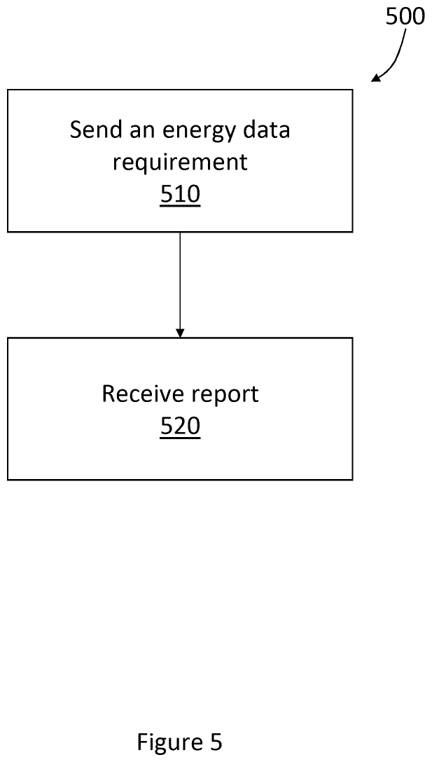

FIG. 5 illustrates a method 500 for obtaining energy data for an application service, the method 500 comprising: sending 510 an energy data requirement for the application service to a data collection node; and receiving 520 from the data collection node a report comprising a second set of energy data, the second set of energy data computed from a first set of energy data, the first set of energy data collected from a set of energy data producers determined to be associated with the application service from which to collect energy data based on the energy data requirement.

The method may be performed in an AEDC. The data collection node may be an AEDP.

There is further provided a network node for obtaining energy data for an application service, the network node comprising a transmitter and a receiver. The transmitter is arranged to send an energy data requirement for the application service to a data collection node. The receiver arranged to receive from the data collection node a report comprising a second set of energy data, the second set of energy data computed from a first set of energy data, the first set of energy data collected from a set of energy data producers determined to be associated with the application service from which to collect energy data based on the energy data requirement.

The method may be performed in an AEDC. The data collection node may be an AEDP.

In 3GPP TS 22.261 v18.5.0, energy efficiency is captured for the network side to allow an energy saving mode for the RAN side. 3GPP TS 22.261 v18.5.0 also provides requirements for the UE side energy efficiency. For example, section 6.15 of 3GPP TS 22.261 v18.5.0 states that “Energy efficiency is a critical issue in 5G. The potential to deploy systems in areas without a reliable energy source requires new methods of managing energy consumption not only in the UEs but throughout all components of the 5G system. Small form factor UEs also typically have a small battery and this not only puts constrains on general power optimization but also on how the energy is consumed. With smaller batteries it is more important to understand and follow the limitations for the both the maximum peak and continuous current drain.”

Furthermore, TS 22.261 v18.5.0 provides requirements on energy efficiency for the UE side for particular services (e.g. use of ranging services) as well as for different types of UEs (e.g. relay UE). It is presently unclear whether the prediction on a service and/or UE demand can allow for more optimized actions by the 5GS with respect to energy saving. Furthermore, it is not apparent whether an energy saving decision needs coordination with the end customer, and particularly the vertical customer, who would expect no service performance and availability degradation.

3GPP TS 28.310 v17.3.0 specifies the work in 3GPP related to energy efficiency. It specifies use cases relating to energy efficiency such as switching off edge user plane functions for low-latency communication in certain geographical areas when no user is actively using them. The main requirements among the scenarios presented in the technical specification are requirements related to Power, Energy and Environmental measurements as well as requirements concerning energy saving. The technical specification further defines KPIs related to energy efficiency of NG-RAN and different network slices before describing a solution for energy saving. The solutions presented therein primarily involve setting appropriate management entity in an energy saving state in a centralized or distributed manner. It should be noted that the energy consumption of a network slice can be calculated and is available to any authorized consumer via the performance management service producer.

In 3GPP TR 28.813 v17.0.0, the interaction between the Network Data Analytics Function (NWDAF) and Management Data Analytics Service (MDAS) is discussed as part of a key issue in clause 4.3. In this clause, a potential solution is described, where the 3GPP management system, in particular the Management Data Analytics Function (MDAF) subscribes to the NWDAF output during preparation phase and collects data from the various NFs and management service producers during the observation phases. This includes NWDAF analytics outputs. The MDAS then provides an analytics report using said data to the management function in charge of saving energy.

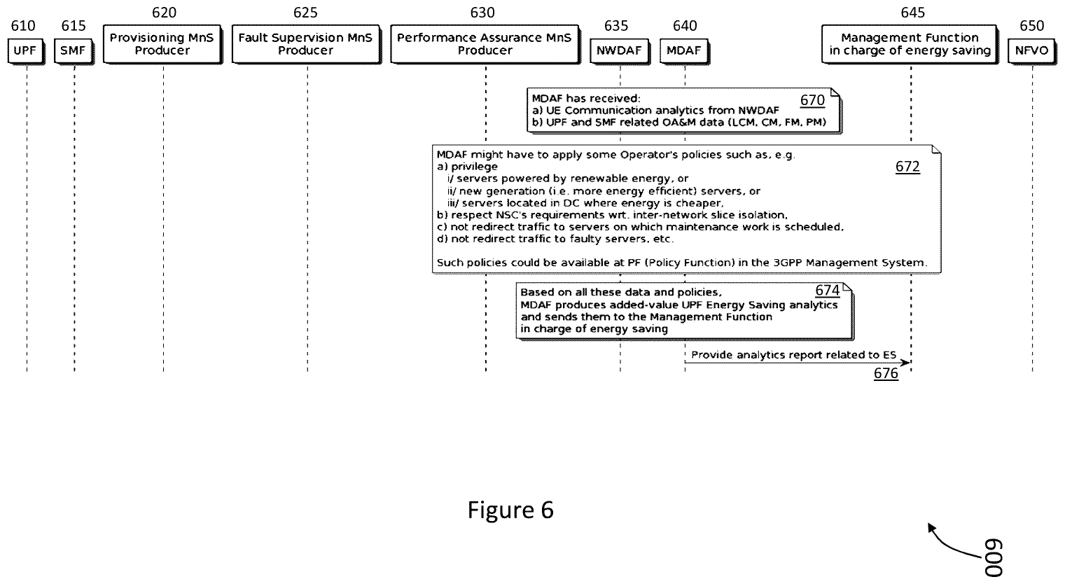

The Management Function in charge of energy saving, consumes analytics produced by MDAF and takes appropriate decisions to save energy in the 5G core network. FIG. 6 illustrates the message exchange between 5GC and OAM in an analytics phase. The illustrated system comprises a user plane function (UPF) 610, a session management function (SMF) 615, a provisioning Management Services (MnS) Producer 620, a fault supervision MNS producer 625, a performance assurance MNS producer 630, an NWDAF 635, an MDAF 640, a management function in charge of energy saving 645, and a network function virtualization orchestrator 650.

In operation, at 670, the NWDAF 635 sends to MDAF communication analytics and OAM data related to UPF/SMF.

At 672, the MDAF 640 derives UPF energy saving analytics. Such analytics can be about recommendations to RAN nodes and UPFs to enter energy saving mode or to re-select UPF/RAN nodes to ensure low energy consumption.

At 674, the MDAF 640 exposes such analytics to the MF in charge of energy saving for the network and/or slice thereof. At 676, the MDAF 640 provides an analytics report to the management function in charge of energy saving (ES) 645.

It is further noted that according to 3GPP TS 28.554 v17.5.0 and TS 28.310 v17.3.0, the 5G KPIs have been defined from a management perspective, and these include the Energy Efficiency KPIs related to RAN, CN and slice. For example, for a generic network slice the EE is defined as the performance of a network slice divided by th energy consumption of the network slice. Performance of the network slice is defined per type of network slice. The Energy Consumption of the network slice is defined independently from any type of network slice. For one unit of Energy Consumption, the higher Performance is, the higher the generic network slice EE KPI is, that is the more energy efficient the network slice is. There are also different EE metrics for different slice types, e.g. for eMBB or URLLC where the calculation is based on different factors (e.g. URLLC is based on latency).

3GPP SA6 is the application enablement and critical communications applications group for vertical markets. The main objective of SA6 is to provide application layer architecture specifications for 3GPP verticals, including architecture requirements and functional architecture for supporting the integration of verticals to 3GPP systems. With respect to application enablement, the main focus is on enablers for vertical applications (e.g. automotive) and service frameworks (e.g. Common API Framework, Service Enabler Architecture Layer, Edge Application enablement).

The Application Data Analytics Enablement Service (ADAES) is defined by 3GPP TR 23.700-36 v 0.1.0 and is a new enablement service. ADAES can be part of Service Enabler Architecture Layer (SEAL). ADAES is presented as facilitating new potential application data analytics services (statistics and/or predictions) to optimize the application service operation by notifying the application specific layer, and potentially 5GS, for expected and/or predicted application service parameters changes considering both on-network and off-network deployments (e.g. related to application QoS parameters).

With regards to energy constrained devices such as IoT devices, application enablement is covered in the SEAL framework specified in TS 23.434 v17.4.0. The use of the Light-weight Protocol (LWP) for constrained environments and in particular the use of Constrained Application Protocol (CoAP) (which is defined by IETF in RFC 7252) as transport protocol for the communication between SEAL server and SEAL clients. CoAP provides a request and/or response interaction model between application endpoints, supports built-in discovery of services and resources, and includes key concepts of the Web such as URIs and Internet media types. CoAP is designed to easily interface with HTTP for integration with the Web while meeting specialized requirements such as multicast support, very low overhead, and simplicity for constrained environments.

The application enablement layer supports the communication over LWP for constrained devices; however it lacks support for defining an energy constrained scenario and for providing specific enablement capabilities for supporting energy constrained devices (e.g. via monitoring energy levels etc).

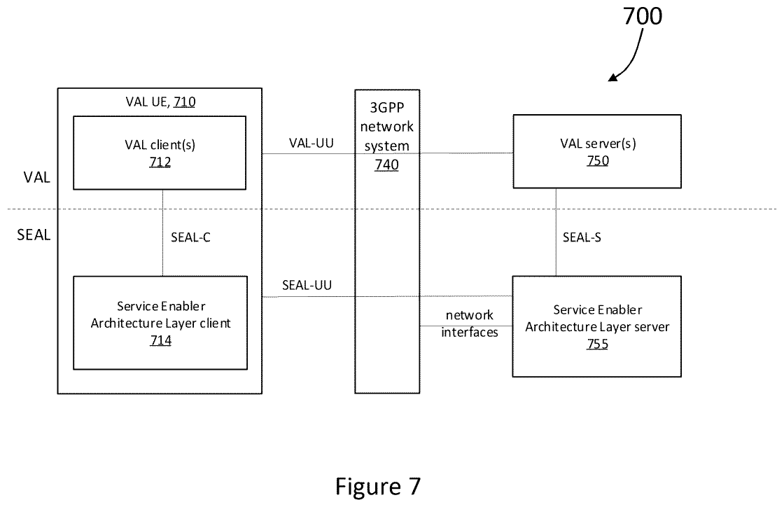

FIG. 7 illustrates an on-network SEAL model. An ADAE can be implemented as a particular service of SEAL. The illustrated system 700 comprises a VAL UE 710, a wireless communication network 740, a VAL server 750, and a SEAL server 755. The VAL UE 710 may comprise a user equipment apparatus 200, a UE 810, 820, or a VAL UE 1141, 1142, 1143 as described herein. VAL UE 710 comprises a VAL client 712 and a SEAL client 714. The VAL client 712 and the VAL server 750 are part of a VAL layer and communicate using VAL-UU. The SEAL client 714 and SEAL server 755 are part of the SEAL layer and communicate using SEAL-UU. The SEAL server 755 has network interfaces to allow it to communicate with the wireless communication network 740.

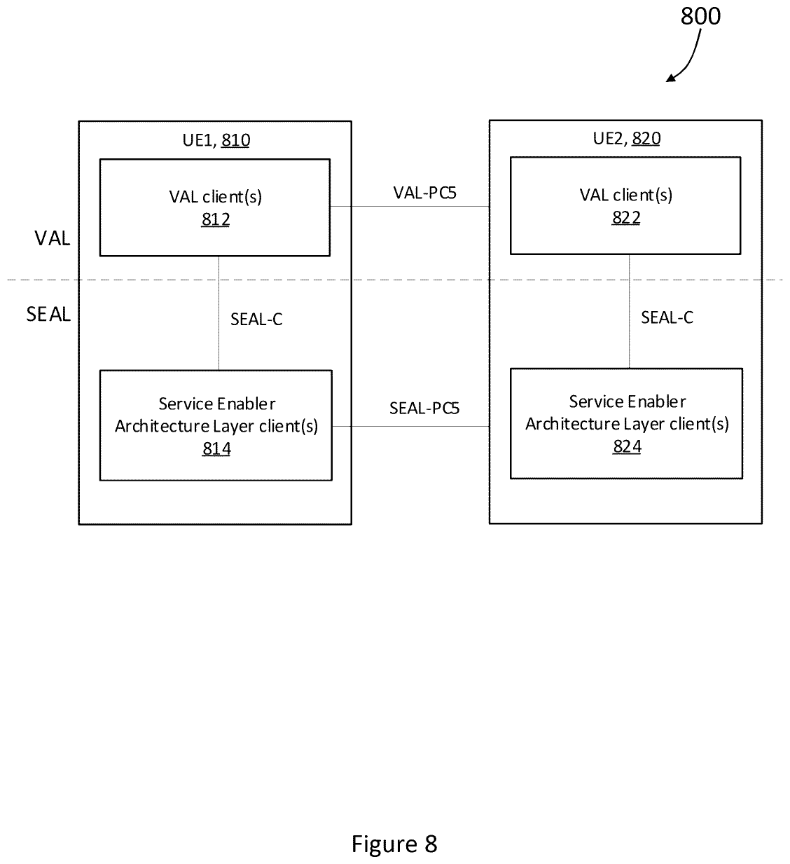

FIG. 8 illustrates an off-network SEAL model. The illustrated system 800 comprises a first UE 810 and a second UE 820. This model is used for allowing the local exchanging of application parameters locally between VAL UEs e.g. in out of coverage scenarios or group-based VAL-UE to VAL UE communications. The UEs 810, 820 may each comprise a user equipment apparatus 200, a VAL UE 710, a UE 810, 820, or a VAL UE 1141, 1142, 1143 as described herein. The first UE 810 comprises at least one VAL client 812 and a SEAL client 814. The second UE 820 comprises at least one VAL client 822 and a SEAL client 824. The VAL clients 812, 822 of each UE are part of a VAL layer and communicate using VAL-PC5. The SEAL clients 814, 824 are part of the SEAL layer and communicate using SEAL-PC5.

The solution presented herein is applicable for scenarios where an application service (or end-to-end service) between two or more application entities (app clients or app servers or both) utilizes one or more wireless communication networks comprising one or more mobile operators' networks. Such networks can be PLMNs or NPN.

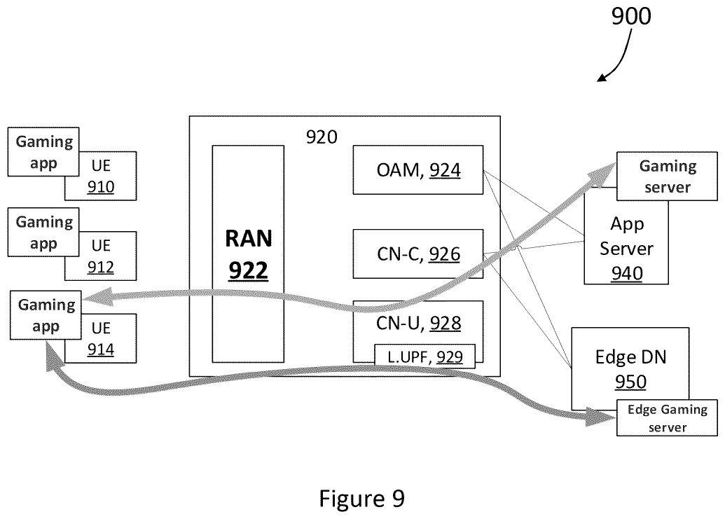

FIG. 9 illustrates a system 900 for implementing an application service for gaming. The system 900 comprises a plurality of UEs 910, 912, 914, a wireless communication network 920, an application server 940 and an edge data network 950. The wireless communication network 920 comprises a radio access network 922, and OAM 924, a core network controller 926, and a core network user plane function 928. Each UE 910, 912, 914 is able to execute a local gaming application. Application server 940 hosts a gaming server. Edge Data Network 950 includes an edge gaming server. The UEs 910, 912, 914 communicate with the application server 940 and edge data network 950 via the wireless communication network 920.

In operation, the gaming application is running for a set of UEs (in this case UEs 910, 912, 914) and communicates with the edge gaming server which is hosted at the edge data network 950. The edge data network (EDN) 950 may comprise a DN or an EDN or both; the latter possible via different instances of the server. In this example, the energy consumption for the application service is the total energy consumption for:
user plane data transfers between the gaming application client and the gaming servers, such user plane data transfers facilitated by UE-RAN-UPF-DN communication;
the control and management plane features which are needed for the application service, for example QoS monitoring and SLA monitoring. Such features impact the application service by requiring the invocation of APIs from the 5GC and/or OAM; and
the enablement layer capabilities which are needed for the application service. Such enablement layer capabilities include the processing needs at the devices (for deploying an enabler client) at the DN/EDN (for instantiating and running an enabler server) and propagation needs for client-server interactions.

The example system 900 shows the possible sources of energy consumption for the application service which can be due to the application traffic exchange over 5GS, as well as the API invocations (northbound APIs, client-server APIs, client APIs, enablement APIs), and enablement services which can be co-located with the application servers at the DN side (can be seen as PaaS/SaaS services at the platform).

An Energy Efficiency KPI has been provided in 3GPP TS 28.554 v17.5.0, focusing on the RAN, CN, slice EE and Energy Consumption (EC) aspects. There is disclosed herein a method for calculating the application service energy consumption and energy efficiency metric based on a consumer's request, and for sending the output to the consumer. The method may be performed by an application enablement entity at the DN or UE side. The consumer may be a management system entity or a third party application.

A method at an energy data enablement function (such as a SEAL, or an MnS) may include receiving an energy related request for an application service or service profile (e.g. IoT service #x) from a consumer, this request asks for how much energy an application service consumes or is expected to consume (based on the profile). This request may also include the energy requirements for the service, e.g. a maximum of X % energy consumption to support certain KPIs/QoS requirements, and an area and time where the request applies.

Such a request may comprise a subscription for receiving periodically the energy consumption per application or based on events, such as when reaching a threshold to notify the consumer.

The method further comprises determining a set of relevant VAL service areas, VAL servers and UEs or groups within the app service and subscription area (e.g. list of cells, geo coordinates) for collecting application usage data or expected data transfers and API invocation. The VAL service areas may be defined by a plurality of EDNs listed on an EDN list. The determining may include obtaining historical data on average application energy consumption. The average application energy consumption may be determined based on application activation time and the number of API invocations and application session times.

The method further comprises collecting energy data for the given application service based on the request for one or more of: OAM, DN, application server, client applications.

Where energy data is collected from OAM, the performance management service producer relevant for energy savings provides statistics on the energy consumption of the 5GS or certain 5G domains.

Where energy data is collected from the DN or server side application the average energy consumption is calculated from DN side/app server for the given application service of a certain type (e.g. IoT servers) within an area. Such consumption can be calculated based on processing load, interface load, and/or API load.

The collection of energy data from the DN or server side application may comprise collection of UL and DL data volumes at N6 endpoint at DN, based on the UL/DL data passing from N6 interface with a certain application traffic descriptor/profile (which matches the requested service).

The collection of energy data from the DN or server side application may comprise listening to a client-server connection (e.g. websocket frames transmitted between a client and a server within a session). This can be an enablement layer client-server session; or this can be listened by the enabler server if traffic delivery occurs via the enablement layer (e.g. SEAL Data Delivery (SEALDD)).

The collection of energy data from the DN or server side application may comprise the application traffic schedules provided by the application server (the timeslots when the application messages are expected to be transmitted/received).

The collection of energy data from the DN or server side application may comprise by the networking stack at DN side (e.g. TCP connection data).

The collection of energy data from the DN or server side application may comprise by the COTS hardware/Network Functions Virtualization Infrastructure layer of the edge/cloud platform (up to implementation how this is received). In telecommunication cloud environments (in ICT domain), the energy measurement for the ICT equipment can be supported by a Remote Management Server (RMS or XRMS) which can provide energy metering from 3rd party perspective and can also provide energy data analysis services which include various reports, with database management, and potential correlation services to understand the power consumption structure and optimization possibilities and progress. Such arrangements are defined in ETSI ES 202 336-12 V1.2.1 and ETSI ES 202 336-1 v1.2.1.

The collection of energy data from the DN or server side application may comprise receiving CAPIF API logs from CCF for a given set of API invokers. The given set of API invokers corresponding to a certain service type.

30) Where energy data is collected from Application clients, the collection may comprise requesting all the VAL UEs (enablement clients) for 1) battery status when a service starts, 2) battery status when a service terminates, 3) time of service, 4) other apps activity, 5) contribution of application to the battery drain if the UE OS supports this information. The collection may further comprise the VAL UEs getting battery status from the OS of the device (e.g. using Battery Status API) or from the apps themselves. The collection may further comprise receiving reports from all the requested VAL UEs.

The method further comprises configuring the data received from one or more data producers in step 3 and calculating the following metrics: Application Data Volume (ADV), Application Energy Consumption (AEC) and Application Energy Efficiency (AEE). These may be calculated based on the energy data collected from the Application clients. For example, the energy data may indicate that IoT service #1 in cell #1 consumes on average 20% battery per minute of session for a given area and time.

The Application Data Volume (ADV) may be calculated in a number of different ways. The ADV may be calculated by summing up UL and DL data volumes at UL/DL data passing from N6 interface with a certain application traffic descriptor/profile that can be captured at the DN side. The ADV may be calculated by summing the received data volume of all client-server connections/sessions of the requested service for a given time window and area (e.g. cell area, service area). The ADV may be calculated by processing the application traffic patterns for all UEs within the application service (e.g. in case of group communications). The ADV may be calculated by summing the number of API invocations and API resources used from certain types of API invokers (e.g. V2X server). The ADV may be calculated by calculating a per slice and per application performance as ADV (data volume percentage of only the application traffic/data volume of the slice). For example, app #1 of slice #1 has ADV 20% of slice data volume in area x.

Application Energy Consumption (AEC) is the energy consumed for the application service in bits per Joule (bit/J).

The ADC may be calculated by summing the 5GS or slice instance or RAN energy consumption (as defined in SA5) and the vCPU usage of all virtual compute resource instances at the edge/cloud and the UE; and multiplying this energy consumption by the % of the resource usage of the application (network and computational resources) against the total resources within 5GS or slice or cell.

$$\frac{Resources ( app \# 1 )}{Resources ( network )} * {EC}_{network} ,$$

where EC_{network} ⊆[EC_{5GC}, EC_{NSI}, EC_{gnB}, EC_{edge}, EC_{cloud}]

The ADC may be calculated by aggregating the battery usage for the application service for all devices within the application service in Joule per bit or per packet for a given time window and area of interest.

The ADC may be calculated by requesting and receiving the energy consumption for one or more application servers for a given time window.

The ADC may be calculated by correlating energy consumption from both UEs and application servers.

The Application Energy Efficiency (AEE) for application traffic of application service is calculated as: AEE=ADV/AEC.

The method further comprises sending the requested energy data for the application (AEC, AEE) to the consumer.

The following examples present different implementations for: derivation of app #1 energy levels based on application data at DN side and 5GS data; and derivation of app #1 energy levels from UEs e.g. based on battery consumption.

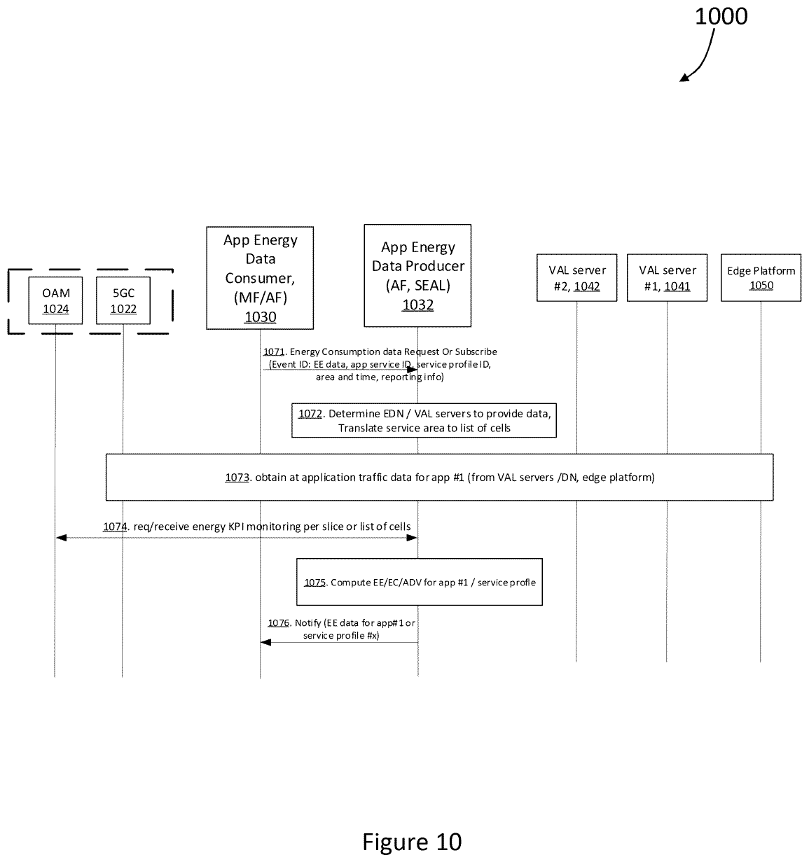

FIG. 10 is a messaging diagram illustrating a system 1000 as described herein. The system 1000 comprises an OAM 1024, a 5G Core (5GC) 1022, an Application Energy Data Consumer (AEDC) 1030, an Application Energy Data Producer (AEDP) 1032, a first VAL server 1041, a second VAL server 1042, and an edge platform 1050. The AEDP 1032, and AEDC 1030 may each comprise a network node 300 as described herein. The new entity described herein is the network or application entity within the communications system, and this resides at the edge/cloud platform. This entity can be an AF or a SEAL entity or an ADAES entity. The function of the new entity is to provide energy data to the consumer (AEDC 1030). The consumer can be an OAM function or a 3rd party application. Such entity in this embodiment is defined as Application Energy Data Producer (AEDP) 1032 and the consumer can be denoted as Application Energy Data Consumer (AEDC) 1030.

The AEDP 1032 may be arranged to collect application data for a given application service or service type (wherein a service type is defined as a set of application services which share similar characteristics in terms of KPIs and traffic patterns within a network/slice service area). Such application data may comprise application traffic patterns and usage for a given service area (e.g. geo, EDN area, list of cells).

The AEDP 1032 may be arranged to the translate of application data to energy consumption data and/or statistics for a given service or service type within a requested service area (requested from the consumer). Such translation may use information concerning the energy per bit and/or packet average spending. Such information may be obtained by the energy resource owner, e.g. platform, OAM

The AEDP 1032 may be arranged to evaluate the energy consumption data, and trigger of an event when the consumption data indicates are reaching/exceeding an energy consumption target threshold (set by the consumer or the owner of the energy resources or the application service provider).

The AEDP 1032 may be arranged to compare the end-to-end energy KPI against the EE KPI for a slice (as defined in TS 23.554 v17.5.0). In particular, the Performance Management measurements and the EC per slice may be used together with application data to calculate the expected energy consumption and energy efficiency for the application service.

The AEDP 1032 may be arranged to communicate the energy data to the consumer. The communication may be periodically or based on the triggered event.

The AEDP 1032 may be arranged to store energy consumption data and/or the generated trigger events at a database for future transactions.

At 1071, the AEDC 1030 sends a request or subscribes to the AEDP 1032 for energy related data for an application service. The request indicates the data needed, such as AEE, AEC, and/or ADV. The request may additionally include at least one of the application service profile or ID, the service and traffic requirements, the PLMN/NPN ID to be used, the area of subscription (geo or topological area or EDN list), and the time and criteria for the reporting.

At 1072, the AEDP 1032 determines the edge platforms 1050, the underlying network/slices or the app servers 1041, 1042 that offer similar service for which the energy data of the application service will be measured.

At 1073, the AEDP 1032 collects data for deriving the energy data (which may be AEE/AEC/ADV). The data is collected based on the producer from which the data is collected. For ADV from the DN side, data can be collected by the application servers or the networking stacks at the edge/cloud, or based on API usage by enablement layer/CAPIF. For AEC: data from the edge/cloud platform can be collected for the vCPU usage. For AEE: data can be derived based on AEC and ADV, or by requesting/receiving such data from application specific layer (e.g. in similar manner as receiving QoE measurements).

At 1074, the AEDP 1032 requests and receives energy KPI data from OAM 1024 (or from the MF relevant for monitoring EE) and in particular per slice instance energy consumption, or per slice subnet energy, or per RAN energy levels or the energy levels for a given geographical area. The energy KPI data may be for the list of cells within the service area. Such data consumption may require that the AEDP 1032 is a trusted entity for the OAM 1024 and that the AEDP 1032 is authorized to receive this data. Accordingly, further authorization of the request may be performed before energy data is returned to the AEDP 1032 by the OAM 1024.

At 1075, the AEDP 1032 derives the requested energy related data (ADV, AEE, AEC) based on the collected data in step 1073.

At 1076, the AEDP 1032 sends the data to the consumer based on the request/subscription in step 1071. Such data can be the ADV, AEE, AEC for the requested application service or service type. Such data may be limited to a particular service area. The particular service area may be limited by geographical, network topological, or temporal restrictions.

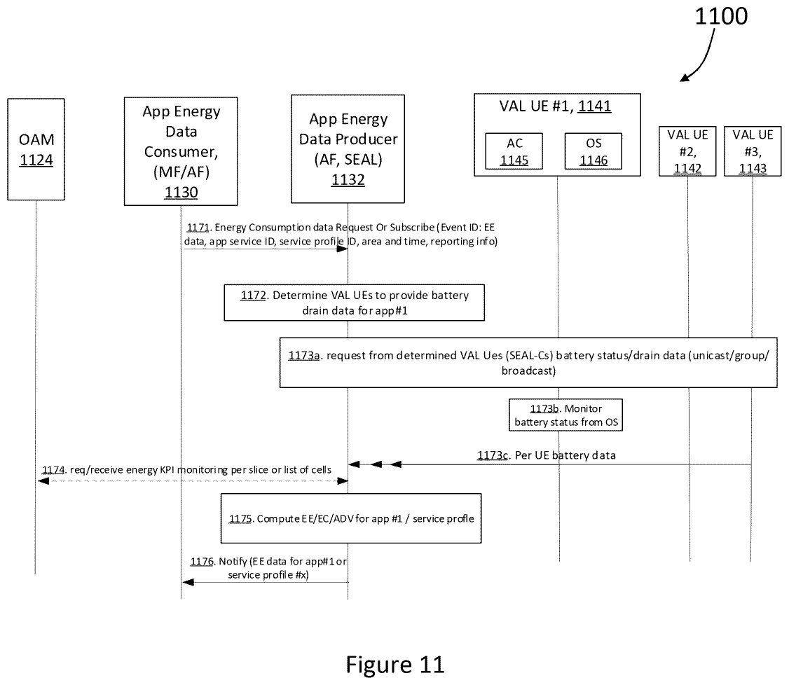

FIG. 11 is a messaging diagram illustrating an alternative system 1100 as described herein. The system 1100 comprises an OAM 1124, an Application Energy Data Consumer (AEDC) 1130, an Application Energy Data Producer (AEDP) 1132, a first VAL UE 1141, a second VAL UE 1142, and a third VAL UE 1143. Each VAL UE 1141, 1142, 1143 may comprise a user equipment apparatus 200, a VAL UE 710, or a UE 810, 820. Each VAL UE comprises an application client 1145 and an operating system 1146. The AEDP 1132, and AEDC 1130 may each comprise a network node 300 as described herein. Here, the new entity is the AEDP 1132. AEDP 1132 is a network or application entity within the communications system which resides at the edge/cloud platform and has interaction with application client counterparts in one or more UEs running a certain application type (e.g., gaming application) with certain application QoS/KPI attributes and traffic requirements. AEDP 1132 may be a SEAL entity, and function to provide energy data to the consumer. The consumer in system 1100 is AEDC 1130, which can be an OAM function or a 3rd party application. Energy data may be provided to the consumer using data collected from the application enabler clients at the UEs running the target application service.

The AEDP 1132 may be arranged to determine a set of VAL UE clients in the target service area to collect battery status data and the battery consumption related to the application.

The AEDP 1132 may be arranged to collect application data for a given application service. Such application data comprise application traffic patterns and usage for a given service area (e.g. geo, EDN area, list of cells). The given service area may be limited by geographical, network topological, or temporal restrictions.

The AEDP 1132 may be arranged to compute the energy consumption and efficiency based on the per VAL UE and the aggregated for all UEs energy consumption data (based on the determined list of UEs), and optionally the triggering of an event when the data are reaching/exceeding an energy consumption target threshold. The target threshold may be set by the consumer or the owner of the energy resources or the application service provider.

The AEDP 1132 may be arranged to communicate the energy data for the application service to the consumer and to identify a cause or method of reporting. The method of reporting may comprise periodically or based on the triggered event. The AEDP 1132 may be arranged to store UE-based energy consumption data and/or the generated trigger events at an edge database for future transactions.

At 1171, the AEDC 1130 sends a request or subscribes to AEDP 1132 for energy related data for an application service. Such request indicates the data needed, e.g. AEE, AEC, ADV. The request may further include at least one of the application service profile or ID, the service and traffic requirements, the PLMN/NPN ID to be used, the area of subscription (geo or topological area or EDN list), the time and criteria for the reporting and/or the method of data collection to be from UEs.

At 1172, the AEDP 1132 determines the VAL UEs within the service area and within the application service/profile with ongoing services for which the energy data will be measured.

At 1173a, the AEDP 1132 requests battery status for the determined list of UEs, for deriving the energy data (AEE/AEC/ADV). Such request may be towards an enabler client at the UE (like SEAL-C or EEC or ADAEC or SEALDD-C) and include one or more of the 1) battery status when a service starts, 2) battery status when a service terminates, 3) time of service, 4) other apps activity, 5) contribution of app #1 to the battery drain if the UE OS support.

At 1173b and 1173c, each of the VAL UEs 1141, 1142 and 1143 and in particular the application client/enabler client interact with OS to fetch the battery status levels and drain measurements. Then, the enabler client of each VAL UE 1141, 1142 and 1143 sends the data to the AEDP 1132. The AEDP 1332 may be an enablement server counterpart.

At 1174, the the AEDP 1132 may optionally request and receive energy KPI data from the OAM 1124. The energy KPI data may be from the MF relevant for monitoring EE. The energy KPI data may be, in particular per slice instance energy consumption, or per slice subnet energy, or per RAN energy levels (for the list of cells within the service area). Such data consumption may require that the AEDP 1132 is a trusted entity of the OAM 1124 and is authorized for receiving this data. The method may additionally include the request from the AEDP 1132 being authorized before the OAM 1124 replies.

At 1175, the AEDP 1132 derives the requested energy related data (ADV, AEE, AEC) based on the collected data in step 1173c by analysing the collected data. The collected data may be analysed after aggregating data from all UEs. Such energy data can be, for example, that for the application service the average energy consumption is x % per device, or the aggregated energy consumption for the application service within an EDN area is X Joules/bit or the energy efficiency is Y bits/Joule.

At 1176, the AEDP 1132 sends the data to the consumer based on the request/subscription in step 1171. Such data can be the ADV, AEE, AEC for the requested application service or service type.

The energy efficiency in 3GPP is calculated for different granularities (RAN, CN, slice, CS). However there is no means of calculating the energy consumption and efficient per application service (e.g. gaming app, vertical service) considering all energy contributors. A problem that tends to be solved is how to calculate the energy consumed by a communication service that can be associated to a particular vertical/3rd party customer who owns the application service.

The solution provided herein comprises a method at an application enablement entity at the DN or UE side for calculating the application service energy consumption and energy efficiency metric based on a consumer's request, and for sending the output to the consumer. The consumer may be the management system entity or a 3rd party application. Such calculation is based on inputs received from the DN/app server side and/or by the UEs running the application based on real time battery status data.

Known arrangements fail to compute energy efficiency for an application service; where the application service uses the 5G/6G system for the communication. Known arrangements only compute energy efficiency for managed entities (CS, slice, NF,) at the OAM. Alternatively, as presented herein, in this solution the computation is end-to-end for the application services and collects data from application as well as network sources.

According to the arrangement of FIG. 10, the AEDP is an enablement entity which collects data from DN and OSS to derive the energy level calculation for an application service.

According to the arrangement of FIG. 11, the AEDP is an enablement entity (which has also a client counterpart at the UE side) which collects energy/battery usage data from the UEs running the application services within an area and time window; and based on this information it derives the energy level calculation for an application service.

There is provided herein a method for providing energy data for an application service, the method comprising: receiving an energy data requirement for the application service; determining a set of energy data producers, within the application service, to collect energy data based on the requirement; obtaining a first set of energy data for a managed entity from the list of the energy data producers for one or more application sessions and/or from one or more data networks; —computing a second set of energy data for the application service based on the first set of energy data; —sending a report comprising the second set of energy data to one or more further network or application entities.

The requirement may comprise at least one of an energy KPI, a request for energy related data, a time and area of interest. The managed entity may be CS, NS, NF, AF, or edge. The energy data may comprise real time battery consumption data for the application service, edge platform energy consumption data, application server consumption data, or a combination thereof. The second set of energy data may comprise an AEC parameter, an AEE parameter, an ADV parameter or a combination thereof.

The requirement may be received by an application server or client, a management service or function, a network node or a combination thereof.

The energy data producer may comprise one or more of an application client, application enabler client, application server, application enabler server, one or more UE modem functions, one or more network nodes, an edge node.

The first and/or second set of energy data may be stored in a repository/database.

The first and/or second set of energy data may be processed based on different filters, the filters include the RAT, interface, spectrum, network or slice configurations which are used for the application session of the application service.

The reported second set of energy data may trigger an application service requirement parameter adaption.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer
readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for providing energy data for an application service, the method comprising:
receiving an energy data requirement for the application service from a requesting node;
determining a set of energy data producers associated with the application service from which to collect energy data based on the energy data requirement;
collecting a first set of energy data from the set of energy data producers;
computing a second set of energy data for the application service based on the first set of energy data; and
sending a report comprising the second set of energy data to the requesting node.

2. The method of claim 1, wherein the energy data requirement comprises at least one of a Key Performance Indicator (KPI) for the application service, an energy KPI, a quality level for the application service, a request for energy related data, and a time and area of interest.

3. The method of claim 1, wherein the set of energy data producers associated with the application service for a managed entity comprise at least one of:
energy data producers for one or more application sessions;
energy data producers from one or more data networks; and
an energy data producer arranged to collect energy data from a managed entity.

4. The method of claim 1, wherein the set of energy data producers associated with the application service includes a function within an edge platform.

5. The method of claim 1, wherein the set of energy data producers associated with the application service obtain energy data for a network slice associated with the application service to be measured.

6. The method of claim 1, wherein the first set of energy data comprises at least one of:
real time battery consumption data for the application service,
edge platform energy consumption data,
network energy consumption and/or efficiency data,
network slice or slice subnet energy consumption and/or efficiency data,
radio access network energy consumption and/or efficiency data,
energy consumption and/or efficiency data for a managed entity, and
application server consumption data.

7. The method of claim 1, wherein the second set of energy data is at least one of Application Energy Efficiency (AEE), Application Energy Consumption (AEC), and Application Data Volume (ADV).

8. The method of claim 1, wherein the energy data requirement for the application service from a requesting node defines a target area within which energy data is to be collected.

9. The method of claim 1, wherein the request for energy related data indicates at least one of:
the data needed,
the application service profile,
the application service identity (ID),
service requirements,
traffic requirements,
the public land mobile network (PLMN) ID to be used,
the non-public network (NPN) ID to be used,
the area of subscription, or
the time and criteria for the reporting.

10. The method of claim 1, wherein the set of energy data producers includes a plurality of vertical application layer (VAL) User Equipments (UEs).

11. The method of claim 10, wherein the first set of energy data comprises one or more of:
battery status when a service starts,
battery status when a service terminates,
time of service,
activity of applications other than the application service, and
contribution of the application service to the battery drain if the UE Operating System support.

12. A network node for wireless communication, comprising:
at least one memory; and
at least one processor coupled with the at least one memory and configured to cause the network node to:
receive an energy data requirement for an application service from a requesting node;
determine a set of energy data producers associated with the application service from which to collect energy data based on the energy data requirement;
collect a first set of energy data from the set of energy data producers;
compute a second set of energy data for the application service based on the first set of energy data; and
send a report comprising the second set of energy data to the requesting node.

13. A method for obtaining energy data for an application service, the method comprising:
sending an energy data requirement for the application service to a data collection node; and
receiving from the data collection node a report comprising a second set of energy data, the second set of energy data computed from a first set of energy data, the first set of energy data collected from a set of energy data producers determined to be associated with the application service from which to collect energy data based on the energy data requirement.

14. The method of claim 13, wherein the data collection node is an Application Energy Data Producer (AEDP).

15. A network node for wireless communication, comprising:
at least one memory; and
at least one processor coupled with the at least one memory and configured to cause the network node to:
send an energy data requirement for an application service to a data collection node;
receive from the data collection node a report comprising a second set of energy data, the second set of energy data computed from a first set of energy data, the first set of energy data collected from a set of energy data producers determined to be associated with the application service from which to collect energy data based on the energy data requirement.

16. The network node of claim 12, wherein the energy data requirement comprises at least one of a Key Performance Indicator (KPI) for the application service, an energy KPI, a quality level for the application service, a request for energy related data, and a time and area of interest.

17. The network node of claim 12, wherein the set of energy data producers associated with the application service for a managed entity comprise at least one of:
energy data producers for one or more application sessions;
energy data producers from one or more data networks; and
an energy data producer arranged to collect energy data from a managed entity.

18. The network mode of claim 12, wherein the set of energy data producers associated with the application service includes a function within an edge platform.

19. The network node of claim 12, wherein the set of energy data producers associated with the application service obtain energy data for a network slice associated with the application service to be measured.

20. The network node of claim 12, wherein the first set of energy data comprises at least one of:
real time battery consumption data for the application service,
edge platform energy consumption data,
network energy consumption and/or efficiency data,
network slice or slice subnet energy consumption and/or efficiency data,
radio access network energy consumption and/or efficiency data,
energy consumption and/or efficiency data for a managed entity, and
application server consumption data.
